(19) United States
(12) Patent Application Publication
(10) Pub. No.: US 2018/0268339 A1
(43) Pub. Date: Sep. 20, 2018

(54) Analytical system for performance improvement and forecasting

(71) Applicant: Hristo Tanev Malchev, Rancho Cucamonga, CA (US)

(72) Inventor: Hristo Tanev Malchev, Rancho Cucamonga, CA (US)

(21) Appl. No.: 15/917,626

(22) Filed: Mar. 10, 2018

Related U.S. Application Data
(60) Provisional application No. 62/473,181, filed on Mar. 17, 2017.

(51) Int. Cl. G06Q 10/06; G06F 17/50; G06Q 10/04

(52) U.S. Cl. CPC G06Q 10/06393; G06Q 10/04; G06F 17/5009

(57) ABSTRACT

A computer-implemented method comprising collecting and processing data, forecasting performance and identifying, sizing, prioritizing, ranking and presenting for execution performance improvement opportunities. It can be applied in various operational functions (for example, sales, customer care, bill collections, underwriting), operational environments (for example, distributed environments such as branch or retail outlet networks, or centralized environments such as call centers), industries and public sector areas. The system can use preset performance targets or it can generate in an automated way adaptive benchmarks against which to identify, size, prioritize and rank the performance improvement opportunities. It provides analysis and recommendations for improvement at all levels in an organization, starting from its basic operational unit (for example, sales agent or retail outlet).

The present invention is designed to provide answers to recurring management questions, not simply the ability for users to seek and possibly find answers as the current art does. More specifically, the invention relates to a computer-implemented method, which includes collecting and processing data, forecasting performance and identifying, sizing, prioritizing, ranking and presenting for execution performance improvement opportunities. It is designed to forecast performance in a bottom-up manner, from the basic operational unit in an organization (for example, salesperson, customer care agent, collector, bank branch, insurance agency, store, restaurant and so on) up to the highest organizational level. The invention introduces a computer-implemented end-to-end analytical method and a process which bring much greater analytical depth than the current art as well as significant efficiency, speed and consistency. That combination is something that cannot be achieved by humans alone or by humans aided by current technology and methods. It has broad applicability across operational functions, operational environments, industries and public sector areas.

### INVENTION BACKGROUND

There are basic, recurring questions sales and operations managers and their team members down to the individual agent level ask themselves and get asked on a regular basis, often daily. For example:
How am I going to end this month (or quarter)?
How do I compare to my peers?
What is my near-term outlook? (Next month, next quarter, for example.)
And crucially, what do I need to focus on in order to improve my performance? How far will that take me?

It starts at the basic operational unit such as individual agents or stores and rolls up to teams, departments, districts, regions and so on, all the way to the highest organizational level. Answers to those questions help individual agents understand where they stand, where they are headed and what they need to focus their attention on in order to do better. They inform managers at all levels about performance trends and improvement opportunities at their respective levels. They also inform them what they need to work on with their team members, from the individual agent level to teams and larger organizational units. Answers to those questions can also inform senior leadership on strategic decisions regarding resource allocation (marketing budgets, production, staffing levels, inventory levels and so on). They can guide on directing training and development efforts and budgets in crucial customer facing functional areas such as sales, customer care, underwriting or bill collections. These are very important questions in competitive environments or environments where efficiency is primary.

And although the above questions are critically important, finding the answers is more complicated than it seems. First, the focus among reporting and analytical solutions providers has been on assisting end users (or analysts who in effect serve as intermediaries) as they seek answers. The focus has not been on directly providing answers. Whether it is functionalities such as data cubes that make data more easily accessible, or drag-and-drop type functionalities that make it easier for less technical staff to explore different options, or dashboard and data visualization functionalities to assist in various evaluation processes, or drill-down functionalities that allow diving manually into certain detailed aspects, existing solutions only attempt to make it easier to find answers but do not undertake to solve problems from end to end and provide answers.

Second, current art solutions address only specific parts but not the full range—from descriptive, to diagnostic, to predictive and prescriptive analytics:
Descriptive analytics or the “look back” at what has happened in the past—for example, managerial reports and various visualizations, dashboards and drilldowns that leverage the underlying reports—can be built through custom code but in most cases they are built on generic software platforms. That is the analytical area that is best developed, probably because it is easiest to develop.
Diagnostic analytics—various reports typically against static, pre-set targets (rather than dynamic, adaptive targets) for the current period or against prior periods and possibly dashboards or other visualization and reporting techniques to assist in assessing relative performance. Tools and platforms used in that step are similar to those in the prior step.
Predictive analytics—performance forecasting models are built separately from the prior two steps. The more rigorous ones typically focus on longer-term, higher level forecasts.
Prescriptive analytics—in the operational functions targeted by this invention, the prescriptive component is largely non-existent as it relates to operational performance forecasting and improvement opportunity identification, sizing, prioritization and ranking. As such it is left to analysts and end users to produce it manually. Decision science applications and rules engines are too generic and do not have specific methodologies pre-built into them or the pre-built methodologies serve different purposes from those envisioned in this invention. For example, an application designed to detect application fraud or to recommend credit decisions cannot be used to direct salespeople in which customer contact channels and on which customer segments they may have opportunity to increase approvals rates, let alone to identify if extra effort (working hours) or marketing support would provide the most lift in an agent's performance as opposed to focus on specific production steps.

Third, data used to assess improvement opportunities is typically incomplete. Starting opportunity (such as trade area size or assigned leads), effort (such as hours worked or attempts to contact prospects), efficiency (such as percentage productive time or contact rates) and skill (such as closing rate, or average sale or first-time problem resolution rate) are the four major internal factors that determine operational results.

Fourth, analysis is deficient. For example, it does not fully account for opportunity costs when assessing improvement opportunities. That results in overestimating potential improvements. It also results in incorrectly prioritizing certain improvement areas over others as opportunity costs relative to the potential gross improvement in performance vary across areas. Analysis is also incomplete as not all fours factors determining performance (opportunity, effort, efficiency and skill) are taken into account and traded off against each other if necessary to meet constraints.

A solid short-term forecast along with the improvement opportunities quantified and listed can also serve as a solid foundation for bottom-up medium-term planning (annual plan, for example). It provides a sound base case and accurate information about alternative scenarios.

In summary, here are the major gaps between operational needs and current analytical offerings, which the present invention overcomes:
No integrated end-to-end solutions, from descriptive, to diagnostic, to predictive and prescriptive analytics. That makes it extremely difficult for organizations to create custom processes that are coherent, aligned, comprehensive and efficient, and provide the necessary insights across the entire range. As a result, organizations simply do not build such capabilities on their own.
No automated solutions designed to solve problems and provide answers. There are only solutions that assist in seeking answers to some but not all key recurring questions related to operational performance. Thus, manual execution left to individuals whose core responsibilities are not analytics results in the following:
   Consistency issues—whether to seek answers at all, how often to do it, when exactly to do it and how to come up with the answers (methodology).
   Inefficiency—automated solutions run faster and are easier to maintain and run from an organizational perspective
   Lacking simplicity for the end user—direction presented in a clear and concise way is easier on the recipient than having to solve the same complex analytical problems over and over, manually. That can improve employee engagement and satisfaction, with all the accompanying positive organizational benefits.
   High cost
      Direct costs—automated solutions cost less for organizations that have scale even after factoring in implementation costs.
      Opportunity costs—manual processes executed by operational managers take their time and attention away from execution, which results in missed opportunities that in most cases cannot be recovered.
Analytical rigor and accuracy
   Manual processes are extremely time-consuming to execute properly and as a result they are not executed in enough depth.
   Individuals who execute manual processes vary in skills and are typically not trained as analysts. As a result, in addition to potential differences in methodology (mentioned above), there could be errors in executing the analysis.
   Often data inputs are incomplete (see comments on four factors above). Therefore analytical results would be partial and incomplete, hence inaccurate.
   Finally, innovations in analytical methodology related to opportunity identification, sizing, prioritization and ranking are among the key innovations in this submission. My observations and research show analysis today, if done at all, is not done properly in several aspects.

The present invention, combining operational, statistical, economic and financial analysis along with management experience, attempts to overcome the above shortcomings in respect to the operational functions, in the operational environments and in the industries and public sector areas it is applied to.

### BRIEF SUMMARY

The present invention relates to a computer-implemented method and a process related to the method. With respect to the method, it is an end-to-end analytical technique that identifies, sizes, prioritizes, ranks and presents for execution operational improvement opportunities. It also creates short-term performance forecasting scenarios. It can be applied in various functions and various industries as well as non-profit organizations that have similar functions. For example, it can be used to improve sales, customer service efficiency, underwriting and bill collections among others. The method's core components, laid out in logical sequence, are as follows (also see FIG. 1):
1. Preparative Analytics
2. Settings
3. ETL
4. Benchmark Setting
5. Performance Normalization
6. Forecasting
7. Improvement Opportunity Analysis
8. Full Potential
9. Results Presentation

Each component can be viewed as an analytical step with a corresponding analytical technique.

There are two very central components at the core. The first is a segmentation structure along various dimensions. In the various embodiments, those may include factors such as customer segments, products, lead sources, marketing campaigns and so on (including hierarchies within each factor). The segmentation also includes, as a dimension, the critical steps in the core production process (operational value chain) for the particular use case and operating environment. All segmentation dimensions, including the steps in the core production process can be configured and customized to fit the exact operational environment. This component enables the exceptionally detailed analysis performed by the second core component which incorporates several methods that deal with identifying, sizing, prioritizing and ranking potential performance improvement opportunities.

The method can be applied down to the most basic operational unit (individual agent or store, for example). It can be used for bottom-up actions and decisions (individual agent for self-improvement) or it can be used to answer top-down questions (if senior leadership is looking for opportunities).

Automating the analytical process for speed and efficiency and at the same time allowing certain manual adjustments in order to better reflect management judgment or to communicate direction can only be achieved through a software application. The software application can be customized and configured to fit the exact use case and business context.

The method combines descriptive, diagnostic, predictive and prescriptive analytics. It combines operational, microeconomic, financial and statistical analysis.

Several innovative and unique analytical techniques are presented in this invention. There are also several commonly used analytical methods and techniques that are used in order to provide a truly comprehensive, one-stop operational performance management solution, which is also key to this invention.

### DRAWINGS—DESCRIPTION

FIG. 1: Main Phases in Logical Sequence—presents the main phases as the end-to-end process

FIG. 2: Preparative Analytics—describes in summary form the steps related to the setting up the system

FIG. 3: Map Operational Process—describes the framework which includes outside inputs, actions taken and results, in logical sequence, and presents an example

FIG. 4: Defining Segmentation Dimensions and Segments within Dimension—describes the framework which includes various dimension types as discussed in the detailed description and presents an example

FIG. 5: Settings—shows at a high level the three types discussed in this document

FIG. 6: Organizational Hierarchy—shows an organizational hierarchy type which may be used in the core analytical model for roll-up and prioritization purposes. It is not about organizational management but rather about ensuring mathematical feasibility.

FIG. 7: ETL—describes in brief each step in the “extract-transform-load” data process

FIG. 8: Benchmark Setting—describes in brief two possible approaches that may be used in the end-to-end process

FIG. 9: Performance Normalization—starts with a brief narrative before showing the mathematical structure and formulas for normalizing data for known, predictable, enduring and measurable factors

FIG. 10: Forecasting—shows the mathematical structure for the forecasting component

FIG. 11: Possibilities Analyzed and Structure (Hierarchy)—example supporting the detailed description; understanding this structure is critical to understanding the analytical method's building blocks and approach; demonstrates this method's analytical depth

FIG. 12: Comparison Metrics: Nominal Values Versus Ratios Along the Operational Value Chain—describes another important building block in this method—the opportunity identification framework; shows how in some cases nominal values are used to identify improvement opportunities and in other cases ratios are used in order to start from a normalized basis; provides the frameworks and a specific example

FIG. 13: Substitutions—graphically depicts two scenarios that together describe a specific type opportunity costs that need to be considered in some cases in order to arrive at net incremental benefit. Although “products” are used in this example, the opportunity cost estimation methodology may apply to other parameters as well, including points along the process flow.

FIG. 14: Dealing with Zeros—describes the analytical method applied to specific cases where there is discontinuity and practical assumptions need to be made in order to evaluate potential improvement opportunities

FIG. 15: Full Potential—describes another key analytical component that takes an innovative approach and has a specific practical application in performance management

FIG. 16: User Interface Example—demonstrates how the heavy math can be kept behind the scenes, showing only the results that provide direction and a call for action

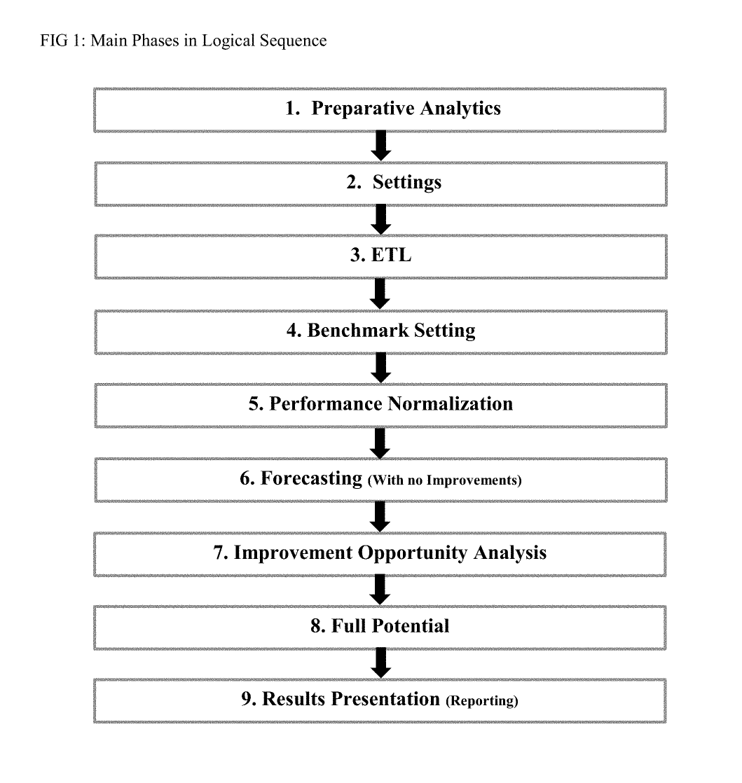

The drawings (identified as FIG and the number) are intended to depict only typical invention embodiments and therefore should not be considered as limiting the invention scope.

### DETAILED DESCRIPTION

The present invention relates to a computer-implemented analytical method. A software application can be built to suit all applicable operational functions and operational environments. An alternative is to build around the same fundamental method simpler and therefore less costly to develop, run and maintain software applications which are tailored to each specific use case (specific operational function and operational environment in which the system is implemented). A third alternative, applicable to simpler use cases, is to implement the end-to-end method utilizing common analytical applications such as spreadsheet applications, possibly integrated with common database applications.

The computer-implemented method can be used for improving performance results and performance forecasting.

The method comprises the following components, laid out as end-to-end process steps in logical sequence. The software application(s), if optimized for speed and computing efficiency, may not follow the same logical sequence. Some steps, as indicated below, may be run outside the custom software application(s) and at lower frequencies for practical purposes.

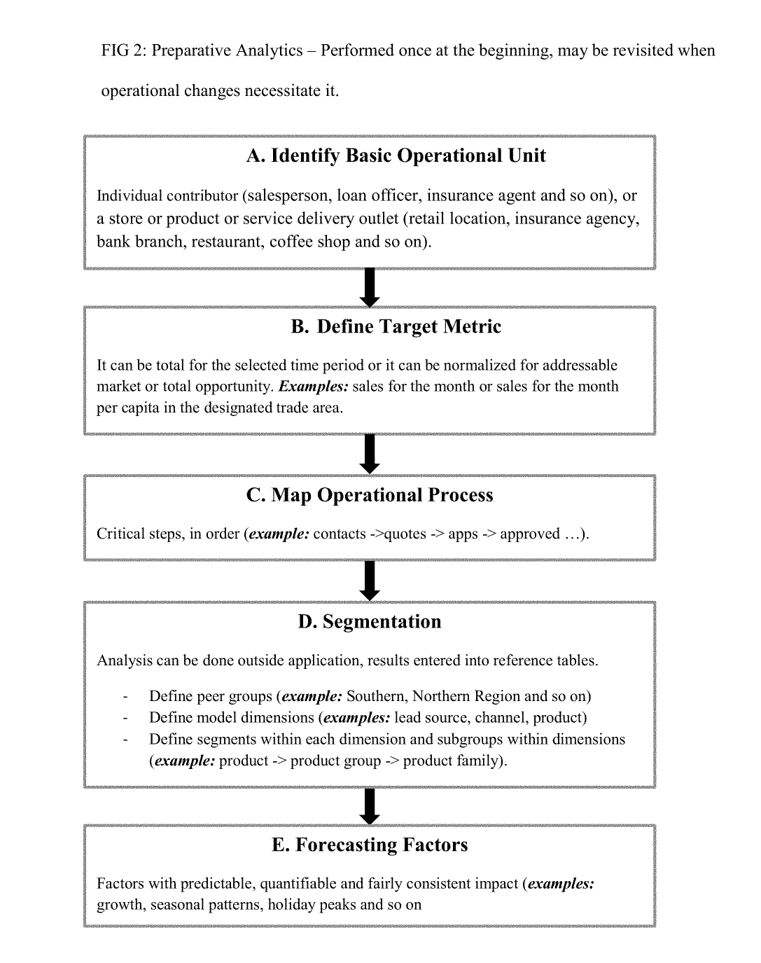

### 1. Preparative Analytics (see FIG. 2)

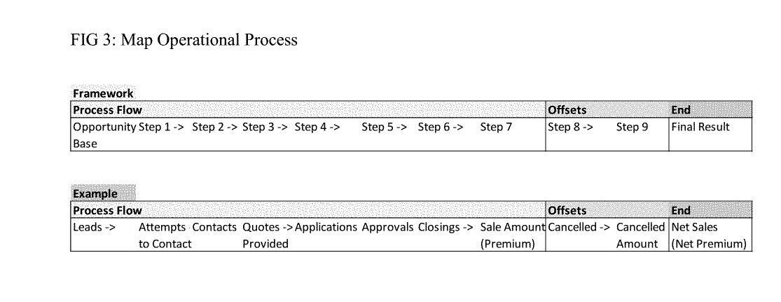

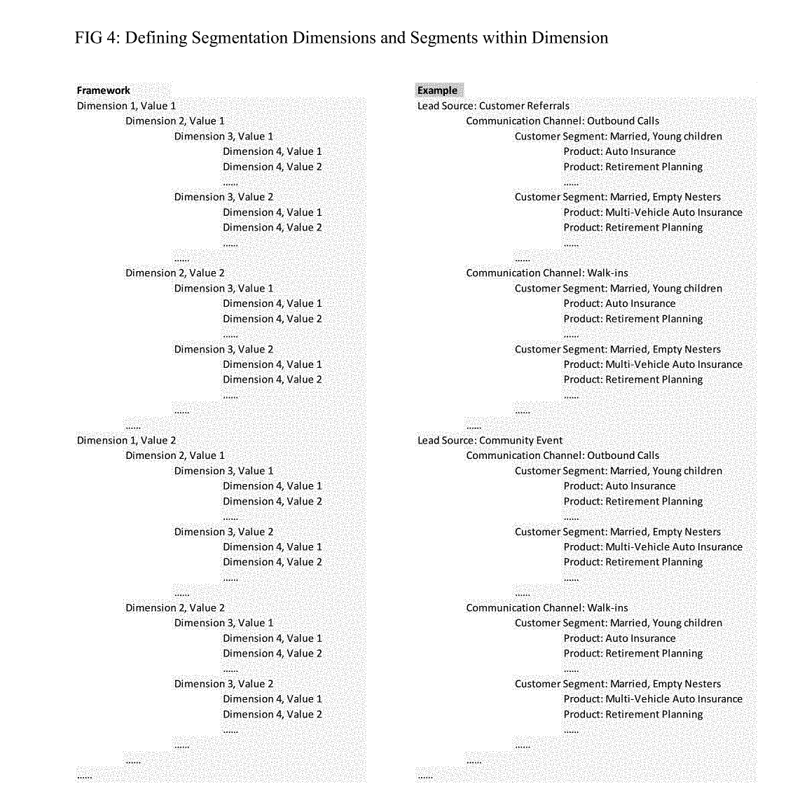

a) Identify basic operational unit (producing unit)—by management decision, it could be an individual contributor (such as salesperson, account manager, loan officer, customer service representative collections agent, realtor and so on) or a product or service delivery outlet (such as a retail location, insurance agency, bank branch, restaurant, coffee shop and so on). The basic operational unit defines the most granular level at which performance and opportunities will be measured and forecasted.
b) Define target performance metric—by management decision, it may be based on current practice at the particular organization or possibly supported by basic qualitative or quantitative analysis. Once defined, it may be reviewed from time to time but not frequently, only if major changes in the operating model occur. Changes to the target performance metric may require revisions to the core analytical model and the entire system setup.
c) Map operational process value chain (see FIG. 3)—determine the critical steps and the sequence (referred to below as the “operational value chain”) that determine the operational outcomes. Example: leads generated→attempts to contact→contacts→net sales.
d) Segmentation (also see FIG. 4 for ii and iii below)
   i. Establish peer groups for the basic operational units subject to the subsequent analysis. The objective is to find groups that perform similar tasks, are presented with similar opportunity, use similar technology and tools, and therefore, in the long run, are expected to achieve similar results. The analysis may involve commonly used qualitative or quantitative methods. This step is on the critical path in implementations where quantitatively set, adaptive benchmarks are used (as opposed to targets set outside the analytical model). Once executed at the time the system is implemented, the results may be reviewed and refreshed at a preset schedule but with a fairly low frequency (for example, once or twice a year) or when significant changes occur in the tasks performed or in the operational environment (for example, in opportunity, technology or tools).
   ii. Identify dimensions, other than operational unit and time, along which performance will be measured, analyzed and forecasted. Dimensions typically considered include, but are not limited to, lead source, marketing channel, marketing campaign, communication channel, product or service, account or customer relationship status, customer segment and so on. The exact dimensions chosen would depend to a great extent on the operational function in consideration and data availability and accuracy. The analysis to select the exact dimensions and define the exact structures, including potentially hierarchies within dimensions, may involve commonly used qualitative or quantitative methods. Once executed at the time the system is implemented, the results may be reviewed and refreshed at a preset schedule but with a fairly low frequency (for example, no more than once a year) or when significant changes occur in the organization's approach to any specific dimension.
   iii. Define the segments within each dimension identified in 1 b). Each dimension may contain intermediate groupings in addition to the segments at the most granular level. For example, Products A, B and C can be viewed separately and in total as Sub-Group 1, while Products D, E and F could be viewed separately and in total as Sub-Group 2. The segmentation analysis along each dimension may involve commonly used qualitative or quantitative methods. Once executed at the time the system is implemented, the results may be reviewed and refreshed at a preset schedule but with a fairly low frequency (for example, no more than once a year) or when significant changes occur in the organization's approach to any specific dimension (for example, adding a major new lead source, changes in product line-up, customer segmentation framework and so on).
e) Forecasting factors—based on quantitative analysis that focuses on factors that are known to impact operational results in ways that are predictable and fairly consistent, and can be quantified accurately. Examples for such factors are seasonal patterns, patterns around specific recurring events such as holidays, growth or decline which are expected to continue, workdays in a month or week and so on. Once executed at the time the system is implemented, the results may be reviewed and refreshed at a preset schedule but with a fairly low frequency (for example, no more than once a year) or when significant changes in operations occur. Management overrides may be applied through adjustment factors built into the system. Such management overrides may be appropriate when there are predictable, measurable, temporary influences.

### 2. Settings

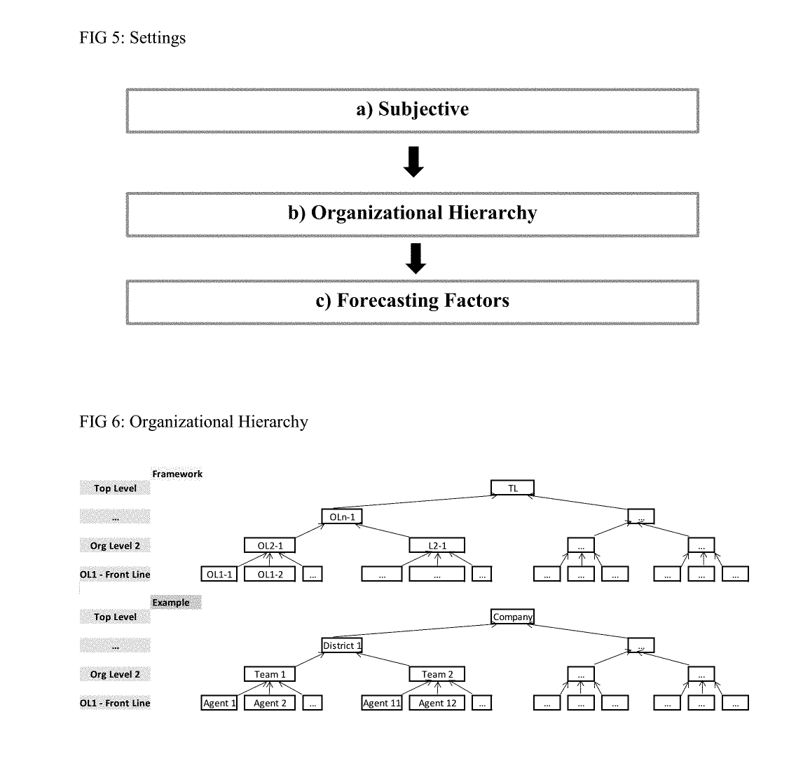

There are three types (see FIG. 5). They are to be used in core model calculations but are to be updated at lower and varying frequencies, not necessarily with every run:
a) Subjective—based on established practices at the specific organization or on management judgment. For example, the practice may be to avoid having employees work more than two hours overtime per shift. Or management at one organization may decide that the appropriate period to establish a short-term trend in performance (referred to as “look-back period” below) is one month while management at a different organization that may be in a different business may decide one quarter is the appropriate timeframe. These settings need to be configured at the beginning and they only need to be revised when the operating environment, practices or management direction change significantly enough.
b) Organizational hierarchy—necessary for roll-ups; it starts from the basic operational unit and rolls up, in steps, to the highest level in the organization (see FIG. 6). This step should be performed outside the core analytical model and the inputs should be entered into the data base, ideally as a reference table that is updated as necessary with every organizational change. Organizational changes may not affect peer group definitions as changes in management structure may not affect opportunity and tasks performed, which are the factors determining the peer groups.
c) Forecasting factors—those are the factors discussed in 1 b) above.

### 3. ETL

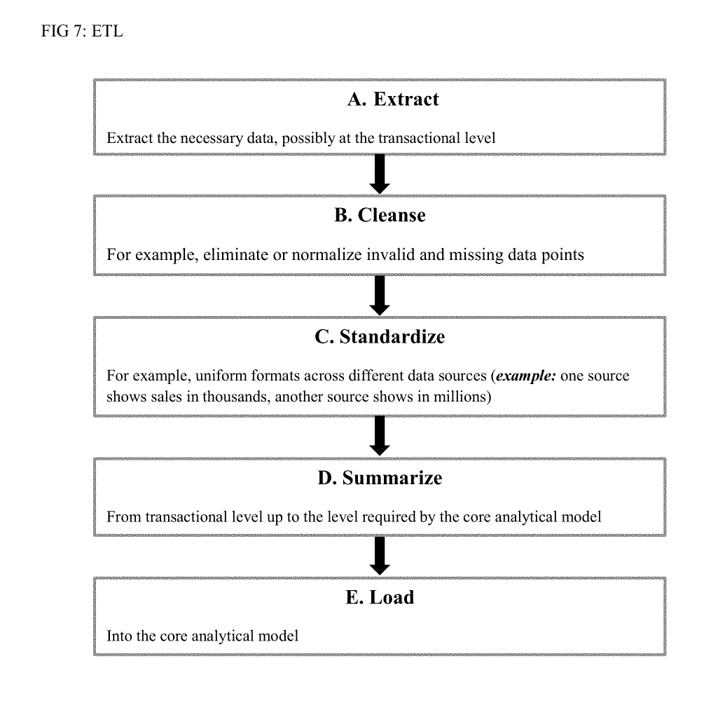

It provides data to the core analytical model for periodic runs (see FIG. 7):
a) Extract the necessary data
b) Cleanse the raw data: for example, eliminate or normalize invalid and missing data points
c) Standardize: if necessary, into uniform formats, especially if certain data components are collected from different sources (for example, measurement unit: show all sales in dollars, not in thousands).
d) Summarize: if data is received at the transaction level, summarize up to the level the core analytical model requires. For example, transaction level data showing outbound phone calls to specific phone numbers made by an agent during a certain day (or shift) can be summarized to show the total outbound calls the agent made that day (or shift).
e) Load: into the core analytical model

### 4. Benchmark Setting

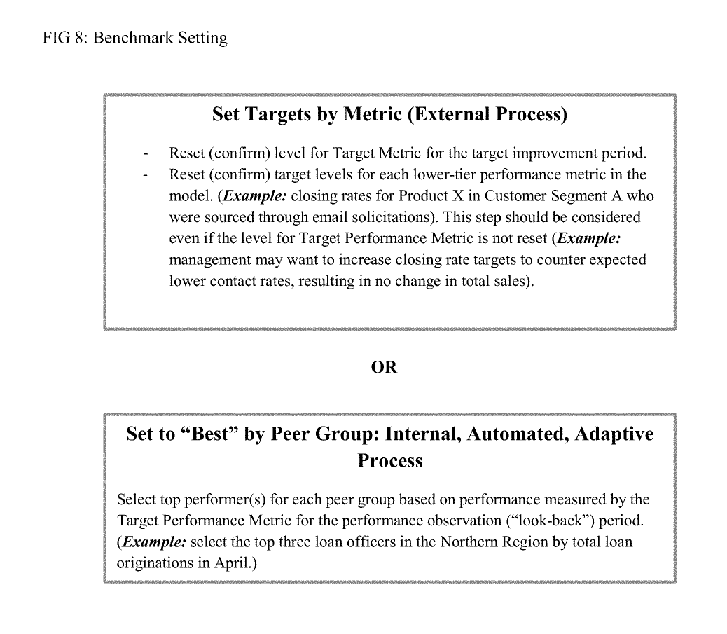

It is needed for performance comparison and opportunity identification and sizing (also see FIG. 8).
a) Performance target setting—there are two ways to accomplish this:
   i. Pre-set performance targets—this is the traditional way. Due to the granularity required in this method, it may be impractical for sophisticated implementations that involve possibilities for each basic operational unit that can easily be in the thousands, for each run. If the runs are frequent, updating the performance targets for each metric involved in the opportunity identification, sizing, prioritizing and ranking analysis becomes even harder.
   ii. Quantitative, automated, adaptive performance target setting—preferred approach by this invention. Performance targets for each metric involved in the opportunity identification, sizing, prioritizing and ranking analysis under this approach are set as follows: first, basic operational units within each peer group are compared by their achievements as measured by the target performance metric during the look-back period. For example, select the highest performing X agents (or delivery outlets) in each peer group. At the next step, if X>1, a “Super Agent” (or “Super Agency”) is created to represent the highest performers by averaging their performance as measured by the target performance metric. If built into the core analytical model (multifactorial analytical model), the performance targets for each metric involved in the opportunity identification, sizing, prioritizing and ranking analysis will automatically refresh with each run as new performance data comes in. This approach clearly lends itself to automation and as such it is scalable, efficient and allows much more analytical rigor. Importantly, it also brings more realism to performance target setting. Lower performers will strive to raise their performance to levels they know are achievable because the top performers have demonstrated that to be possible. At the same time, high performance may not have that much more room for growth in a mature environment. If stretch goals are needed and warranted, those could be set by management through selectively applied adjustment factors. This approach also facilitates best practice sharing by the top performers in the post-analysis phase. As the analysis provides guidance on what to focus on in order to improve performance, best practice sharing can help answer how to do it.
b) Peer group performance averaging—for each peer group that is established for each basic operational unit (individual agent, delivery outlet), by each metric involved in the opportunity identification, sizing, prioritizing and ranking analysis, in each combination. This is necessary to establish for the cases where there is missing performance data and a reasonable assumption needs to be imputed. For example, if an agent has not had any successful contacts with the leads that agent has attempted to reach, they will not have had a chance to continue with the process and close any sales. If the agent were to improve their contact rates that could be worth something. But we would not know what contact rates above zero would be worth unless we make assumptions, for example, how many contacts will result in sales and how large those sales would be. The proposed solution is to assume their chances to close a sale and the sale sizes would be equal to the average for the peer group or some proportion to the average. An assumption the metrics at the following steps in the operational value chain would be far above average results in multiplying improvement opportunities. As such, it should be avoided as it may result in overly optimistic projections.

### 5. Performance Normalization

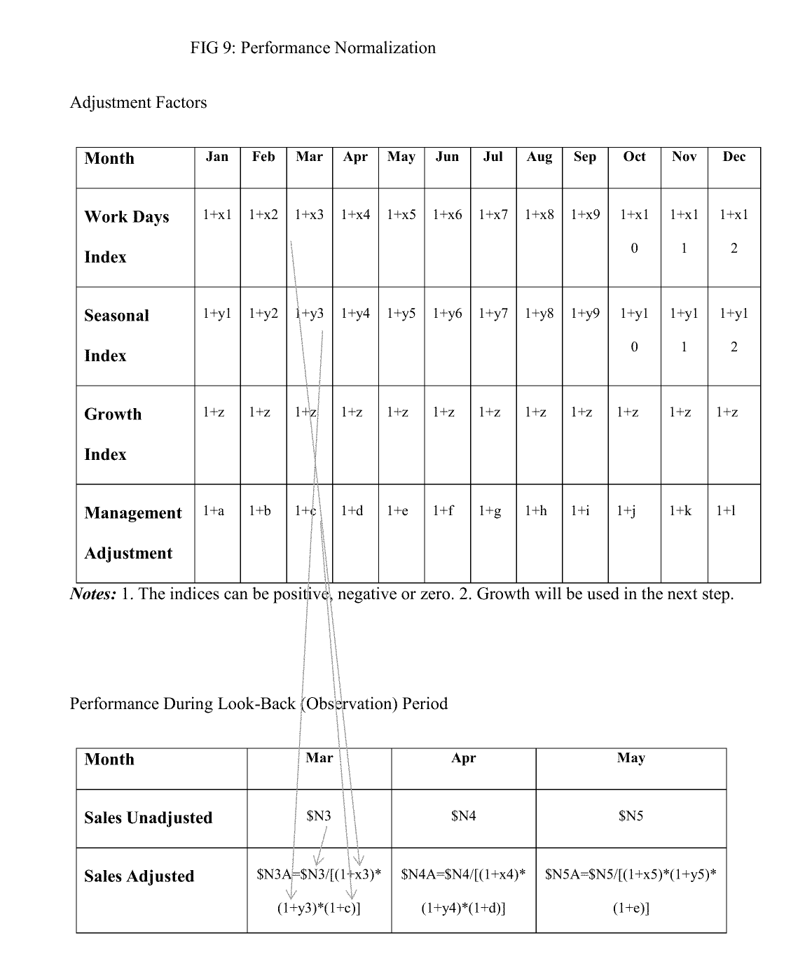

Using past performance (from the look-back period), a baseline is created for the improvement opportunity analysis and for the forecasts (see FIG. 9). The forecasting factors from step 1 d) are used to account for their known, predictable, quantifiable and recurring impacts on performance. Those factors are applied to each performance sub-period (for example, each day in the look-back period if the performance period is calendar month or each month in the look-back period if the performance period is one quarter). Thus normalized performance data for each sub-period is then averaged over the entire look-back period. That would create a normalized daily average if the performance period is calendar month, for example, or normalized monthly average if the performance period is one quarter.

### 6. Performance Forecast

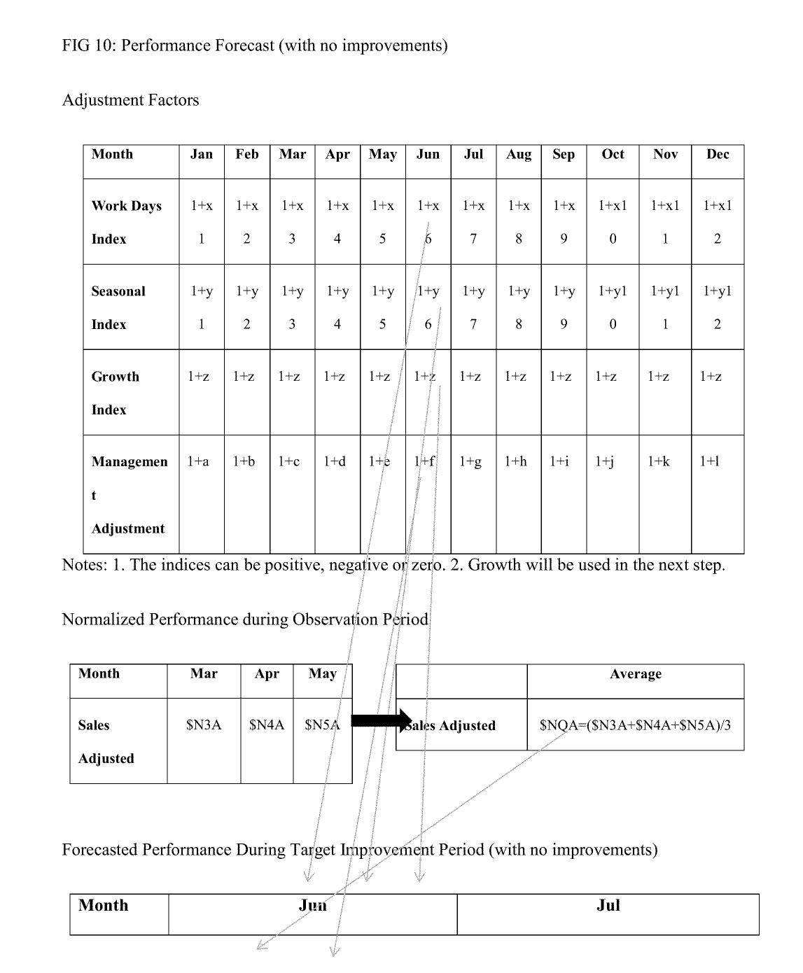

It shows expected performance without any new improvement or deterioration in performance due to management actions. This is a “business as usual” performance forecast, assuming performance levels from the look-back period will continue, including any upward or downward momentum (see FIG. 10). The only elements affecting the performance forecast are the forecasting factors from step 1 d) and performance period length such as working days in a month or quarter, for example. Functionality may be added to allow management adjustments if any inflection points are expected, but adjustments should not be applied due to expected benefits from performance improvements expected from using this system. The forecasts may be two types:
a) Current period—there are two distinct parts to such a forecast. They are calculated separately and then combined:
   i. Period-to-date performance (for example, month-to-date)—uses actual performance data that is not normalized (or has been de-normalized) at summary level (in other words, not transaction level)
   ii. “Period-to-end” performance for the current period—starts with the normalized performance data (see step 5 above) at summary level (in other words, not transaction level) for the entire look-back period, averaged for the most granular sub-period (for example, normalized daily or monthly average), for each basic operational unit (such as agent or delivery outlet). Those data points are then extrapolated across the remaining sub-periods during the current period and adjusted (de-normalized) with the applicable forecasting factors. For example, if the chosen performance is one month and there are fifteen working days remaining in the current month but a particular agent is only scheduled to work twelve days, that particular agent's normalized daily average performance will be taken twelve times separately (for the twelve days the agent is expected to work) and for each working day the normalized daily average performance will be adjusted with the forecasting factors (in effect, reversing the normalization but at the same time ensuring that reflects the expectations for the future period). That results in twelve daily forecasts. If management adjustments are enabled, they can be applied at management's discretion.
   iii. The final step is to sum up the period-to-date actual results and the period-to-end performance forecast. In the above example, that would mean summing up month-to-date actual performance with the twelve daily forecasts for the particular agent.
b) Following period(s)—similar to 6 a) ii. Normalized sub-period averages are applied to each sub-period in the period in focus when the basic operational unit is expected to be functioning (for example, agent is expected to work or store is expected to be open). The forecast factors described in step 1 d) are applied to the normalized values for each sub-period. The new sub-period values thus produced are then summed up to arrive at the forecast for the period in focus. If management adjustments are enabled, they can be applied at management's discretion.

### 7. Improvement Opportunity Identification, Sizing, Prioritization and Ranking

This component employs powerful and truly innovative analytical concepts.
a) Possibilities analyzed and structure (hierarchy). In its opportunity identification, sizing, prioritization and ranking module, a multifactorial analytical model, which represents a multifactorial analytical method, builds from the bottom up, starting from the basic operational unit. It seeks opportunities for each individual combination as defined by the factors described below, including combinations where one or more factors (except Time) are ignored. Combinations where certain factors are ignored can be viewed as roll-ups. The roll-ups help find out if there are any higher level patterns that yield greater opportunity than the opportunities at the more granular levels. However, it should be noted that the scenario where all factors are ignored is not actionable as it would point to no specific improvement opportunities. As such, that scenario is excluded from this process. Here are the factors that define the combinations:
   i. Operational unit—starting from the basic one chosen for the implementation, such as individual agent or delivery outlet
   ii. Time—for example, current period, future period
   iii. Operational dimension—it should be viewed in a sense as a process flow or a value chain that includes the operational unit's core responsibilities and particularly those tasks that most directly lead to success (for example, leads generated, calls made, deals closed), some outside factors (for example, leads assigned, trade area size) and some outcomes (for example, right party contacts, average sale amount). The metrics used at each point measure effort, skill, efficiency and outcomes. For example, effort is demonstrated by how many attempts a salesperson makes to contact a lead or by how many hours they work; skill is demonstrated in a salesperson's ability to close deals (such as closing rate for approved loans); efficiency can be demonstrated in two ways—the time it takes to perform specific tasks (average handle time for phone calls, for example) and how much down time, for example, an agent has. The latter, combined with how quickly that agent performs the tasks assigned to them determines how many calls, for example, the agent handles per hour. All these factors are accounted for in the multifactorial analytical model through the operational dimension.
   iv. Segmentation dimensions—as mentioned above, examples for those could be lead source, marketing (communication) channel, product, customer segment and so on. In some cases, there could be more than one dimension along which a certain object is described. For example, in bill collections delinquent customers are often described by both a behavior score (how they are expected to perform) and how many months past due they are on their bill (how they have actually performed recently). In some cases, there could be subgroups within a single segmentation dimension. For example, the different salads offered a restaurant could be viewed as individual menu items and as products forming the “Salads” subgroup. All these possibilities are accounted for in the core analytical model through the segmentation dimensions.

Here is an example for a combination at the most granular level—all factors have defined values in this example and the assumption is those are the only factors considered in the implementation:
In (somewhat) plain English: by how much would net sales increase if Insurance Agent John were to increase this month his closing rates with young families with children to whom he tries to sell multi-vehicle auto insurance, whom he has sourced through direct mail and who have walked into John's office?
Combination the multifactorial analytical model looks at:

| Factor | Value |
|---|---|
| Operational unit | Insurance Agent John |
| Time | Current month (remainder) |
| Operational Dimension | Closing rate |
| Segmentation: Customer Segment | Young families with children |
| Segmentation: Product | Multi-vehicle auto insurance |
| Segmentation: Lead Source | Direct Mail |
| Segmentation: Contact channel | Office walk-ins |

Here is also an example for a combination at a higher level where some factors are ignored (it can be viewed in effect as a rolled up view at a higher level):
In (somewhat) plain English: by how much would net sales increase if Insurance Agent John were to increase this month his closing rates with young families with children to whom he tries to sell multi-vehicle auto insurance? (Note that in this example the improvement opportunity is assessed without regard to lead source or contact channel).
Combination the multifactorial analytical model looks at:

| Factor | Value |
|---|---|
| Operational unit | Insurance Agent John |
| Time | Current month (remainder) |
| Operational Dimension | Closing rate |
| Segmentation: Customer Segment | Young families with children |
| Segmentation: Product | Multi-vehicle auto insurance |
| Segmentation: Lead Source | All |
| Segmentation: Contact channel | All |

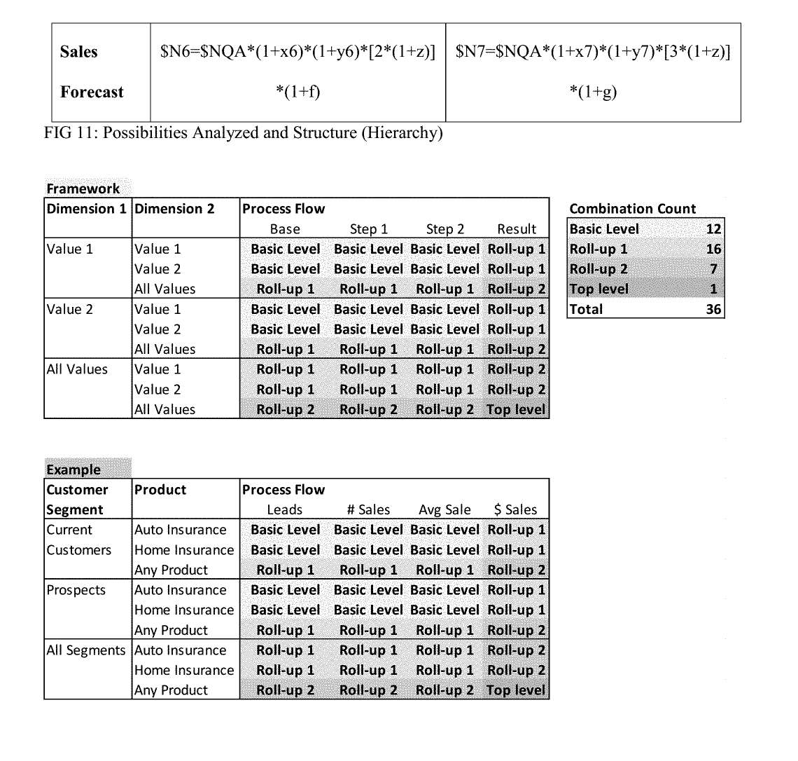

FIG. 11 shows another, more simplified but also more comprehensive example. “All Values” indicates factor does not play a role (it is ignored).

As evident from the description above, this analytical approach combines single-factor analysis (combinations at the most granular level) with multi-factor analysis (represented in effect by the combinations at the higher levels where one or more factors are ignored). That allows a truly comprehensive assessment for any potential improvement opportunities.

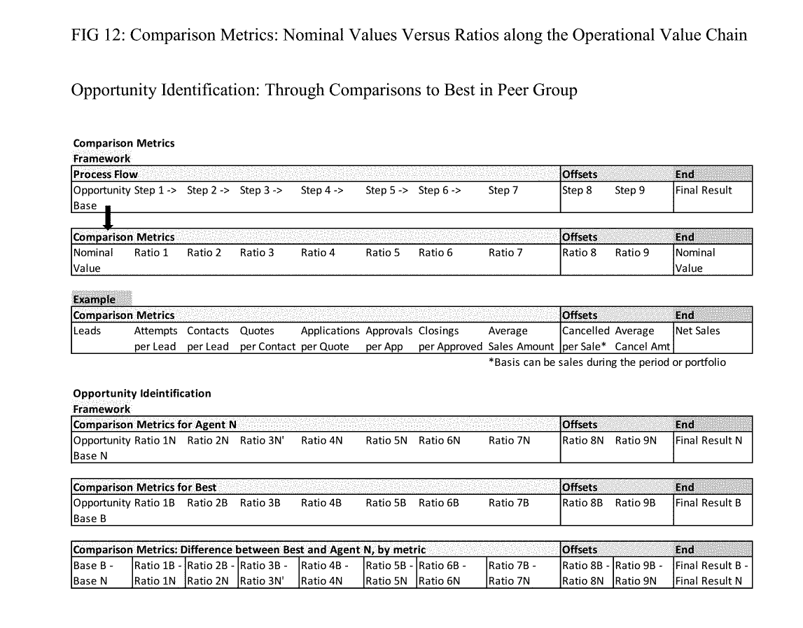

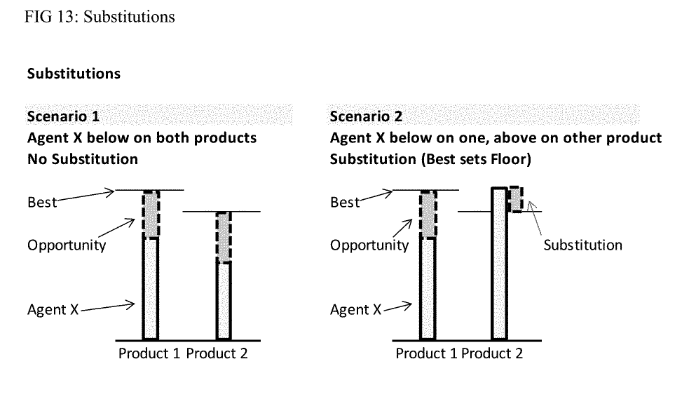

This analytical approach can easily result in having to assess combinations in the thousands for each basic operational unit, with each run. And since a truly comprehensive analysis would require going through all those combinations, it demonstrates this invention's superiority over the current practices that require going through managerial reports manually. Due to the task's sheer size it is clearly unrealistic to expect even a skilled, motivated manager or front-line employee to perform the task in the necessary depth and with the necessary consistency.
b) Multifactorial analytical method for identifying potential improvement opportunities in each combination (combinations described in 7 a) above). Based on the following concepts:
   i. Normalized sub-period averages are used (opportunity values are later extrapolated for period-to-end and de-normalized)
   ii. Comparison to the target, which may be a preset goal or an automatically set, adaptive benchmark based on the achievement demonstrated by the best in the respective peer group. For example, if the target is 4 and the operational unit being studied has achieved 3, the opportunity is 4−3=1. Differences can be positive or they can be negative as goals set by management may be lower than actual performance or a certain operational unit may have higher achievements in certain aspects than, for example, the best in their peer groups. Whether the positive differences indicate opportunity or whether the negative differences need to be ignored will depend on the final calculations that account for opportunity costs (discussed below).
      iii. Nominal values versus ratios—the approach is to follow the operational value chain, with the nominal values taken at the starting and end points, and ratios to the prior point in the sequence used for all points in the middle (see FIG. 12). The rationale is that the starting point determines the opportunity presented to the operational unit. For example, it could be leads assigned, or inbound calls presented by an automated system in a centralized call center environment, or population (addressable market) in the assigned trade area. The starting point (starting opportunity) is typically not under the operational unit's control. Yet, differences in starting opportunity can clearly lead to differences in achievement if all other factors are equal. Ratios are used at the subsequent points in order to normalize for differences from the points leading up to the point being analyzed. For example, if the best performers in the peer group had 100 leads assigned to each and they each made 2 attempts to contact those leads, they will each have 200 attempts recorded. If the agent we are analyzing only had 80 leads assigned and made 2 attempts to contact them, this agent would have 160 attempts in total. The differences would be 20 for leads assigned and 40 for attempts to contact by nominal values. Under the analytical approach in this invention, the difference in leads assigned would remain the same. However, the difference at the following step—attempts to contact—would be 0 (no improvement opportunity in increasing the effort per lead) since both the agent and the best in the peer group made two attempts to contact each lead assigned to them. The analytical approach uses the nominal value at the ending point as well. The metric at each final point for each operational value chain, for each combination is the target performance metric—for example, net sales, net originations, net premium written, net collections and so on. The rationale is that the ending point is in a sense a roll-up, a final outcome. This is a practical approach as it provides clear direction for action. For example, Insurance Agent John's takeaway could be to “Focus on selling multi-vehicle auto insurance to young families with children who are solicited through direct mail and walk into the office”. That would imply improvements over the entire operational value chain. At the same time, the opportunity prioritization logic described further down describes how this invention deals with cases where there is a particular earlier point that accounts for almost the entire opportunity at the ending point.
c) Multifactorial analytical method for sizing potential improvement opportunities in each combination (the combinations are described in 7 a) above). The potential improvement opportunity for each combination, as identified and calculated in 7 b), multiplied by the units at the preceding point in the operational chain for the operational unit in focus (sales agent, for example) in the cases where the potential improvement is expressed as a ratio, is used as a multiplier for the following two components:
   i. Expected value (metric: target performance metric)—calculated for each combination as described above in 7 a), from the most granular to the highest level. For example, “net sales per call” (for the particular combination), or “net originations per approved application” (for the particular combination), or “net collections per right party contact” (for the particular combination). The only exception is at the ending point in each chain where expected value does not need to be calculated. As mentioned above, the final ending can be viewed as an outcome from the starting opportunity and all actions taken prior to the ending point. The ending point is measured in the units for the target performance metric. In some cases, additions could be considered if there are “connected” products (credit insurance sold along with a credit card). There may also be steps (or events) that impact the expected value negatively—returns, rescissions or cancellations, for example. That is why the examples for target performance metrics above are stated as “net” (net sales, net collections, net originations and so on).
   ii. Offsets or opportunity costs—calculated for each combination as described in 7 a) above, from the most granular to the highest level, but only where applicable. Accounting for opportunity costs (or offsets) and providing a method for that is a key innovation and a great improvement over current practices where opportunity costs are not accounted for in day-to-day operational analysis, especially when performed by operational managers or by individual contributors for self-assessment. This inevitably results in overestimating potential improvements. In some cases, where the opportunity costs are greater than the expected gross benefits, the result could be decisions leading to net deterioration in performance especially from the organization's perspective. Ignoring opportunity costs may lead to misalignment between an agent and the organization. The agent may still experience higher results and get compensated for that while the organization will experience a net loss. In other cases, “overachievement” in certain areas may be counterproductive from an organizational standpoint. Opportunity cost analysis may show reallocating resources (for example, the time an employee spends on certain tasks) may be more beneficial. Opportunity costs in the operational areas this invention applies to typically manifest themselves in three ways and may apply individually or in some combination among the three, depending on the specific use case:
Where extra effort in one area takes attention away from another—the question asked here is, “If you do more X, what other things will not get done?” Extra overall effort (such as working longer hours) or concurrently improving efficiency are not considered in order to keep the analysis and potential recommendation simple and clear for better execution. In order to quantify the answer, the following components are multiplied:
   The time it takes the specific operational unit to perform the specific task as well as all remaining subsequent tasks along the operational value chain for that particular combination that result from successfully completing the specific task. Conditional probabilities are used as demonstrated in the following example: the specific task in focus is “attempt to contact a lead” (making a phone call) and it takes one minute; probability to reach the lead is 50% and an actual call with the lead takes three minutes; probability a call will result in a loan application is 40% and the application takes fifteen minutes; the call and the application are the only two tasks after the specific task in focus (attempt to contact); in this example the total time expected for the agent to spend if they were to make one additional attempt to reach a lead is 1+(50%*3)+(50%*40%*15)=5.5 minutes. The question is now “What would the agent have achieved were they to spend those 5.5 minutes on other tasks under their “business as usual” operating mode?”
   The opportunity cost per time unit (for example, per minute) for the time that will be reallocated to the specific task in focus. A reasonable and practical assumption is that if an agent were to focus more on calling a specific customer segment to solicit for a specific product, all other customer segments and products will receive less attention, in the proportion the agent in focus has been allocating time to them. In other words, the agent is unlikely to fine-tune their behavior to the point where they would reallocate a disproportionate time from a specific other task, or customer segment, or product. Under that assumption, the aggregate expected value per time unit (minute, for example) is calculated for all other tasks from which time is expected to be reallocated.
Substitution: where the impact is identifiable—in some cases, increasing focus on one product or service may lead to lower performance on specific other products or services. For example, increasing focus on checking accounts with higher interest rates that also require higher balances may lead to a decrease for basic checking accounts that pay no interest. In other cases, increasing focus on one product or service through one channel, especially if demand is limited, may lead to decrease is performance for the same product or service in another channel. For example, increase in focus on selling a company's branded products through department stores may lead to some decrease in its own outlets. There is a difference between these scenarios and the ones described in the previous paragraph. The ones here are driven by customer behavior and needs (no need for two checking accounts with the same bank, for example). In cases where substitution is well understood and predictable, factors are applied to account for the volume reductions in units for the specific products or services expected to be affected by the increases for the product or service in focus. The factors could be derived through quantitative analysis outside the core multifactorial analytical model. Expert or management opinion could be used as an alternative. The factors are greater than 0 and typically lower than or equal to 1 in aggregate. For example, if increasing focus on Product A results in lower sales for Products B and C, the factors for Products B and C should not exceed 1 in total, unless there is a very strong case for that. The unit volumes are then multiplied by those products' or services' values in order to arrive at the impact on the target performance metric. For example, if that metric is sales, the unit volumes are to be multiplied by the respective unit prices. A 1 factor in aggregate would indicate “one for one” substitution which leads to no improvement in unit volumes between the product or service in focus and the affected substitutes. Financially, that may still be beneficial. The invention also accounts for the possibility that substitution may be expected within certain boundaries. For example, if Products A and B are interchangeable, and Agent X underperforms the best in the peer group in both products. (Let us assume automatically set, adaptive performance targets for this example as the rationale for the argument is easier to see.) Increasing sales for Product A up to the benchmark level does not need to account for substitution as others have proven both Product A and B can be sold in higher volumes. However, if Agent X is underperforming on Product A but is over-performing on Product B, increasing sales in Product A in order to reach the benchmark can lead to lower sales in Product B (opportunity cost), at a certain ratio between 0 and 1 (unless there is a very strong case for a ratio above 1) but that substitution may stop once Product B sales go down the benchmark level (see FIG. 13).
Direct monetary costs—typical examples are labor costs, variable operating costs for retail outlets and marketing costs. For example, if the recommendation is for an agent to work longer hours or for a store to extend its business hours, the associated costs should be applied as an offset to the expected gross improvement in performance. Or, if the recommendation is to assign more leads to a salesperson and those leads need to be purchased, their cost is applied as an offset to the expected increase in performance. In order to apply correctly the concept laid out in this paragraph, labor costs are on a “fully loaded” basis, accounting for any variable general costs (office costs, for example) and management oversight costs. Second, when estimating the costs associated with extending business hours for retail outlets, only variable costs are included (for example, the monthly rent may not increase if an outlet changes its closing time from 8 pm to 9 pm). Third, offset costs (all types) need to be adjusted if the target performance metric is not on the same basis. For example, if “sales” is the target performance metric, a dollar in additional sales typically brings less than a dollar in extra profit while the additional operating costs associated with increasing sales (such as extended business hours for the store in focus) have a direct impact on the bottom line. In bill collections, for example, an extra dollar collected by a collector may not be worth a dollar—there is a chance for the account to “self-cure” (pay the bill without a nudge from the collector) or if there is collateral on a loan, a default may not lead to losing the entire balance. The adjustment is executed by applying a factor (multiplier) to the offset costs that would bring them to the same basis as the expected performance improvements.

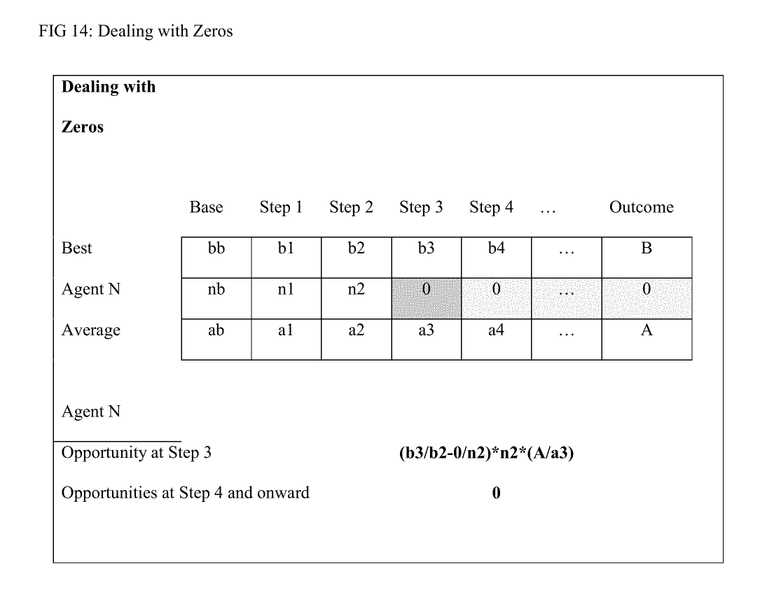

It should be kept in mind that while applying the first two opportunity cost types would not lead to misalignment between organizational and individual (agent) interests, applying direct monetary costs as opportunity costs, especially with an adjustment factor, may lead to misalignment if agents are compensated, for example, for sales rather than profit or total collections rather than dollars saved from default. So, management teams will be encouraged to make decisions with each implementation whether to apply such opportunity costs. A compromise may be considered where the opportunity ranking (see below) is done on a net basis while the opportunity is displayed to the end user on a gross basis but that may confuse end users as in some cases, the gross opportunity amount may be higher than the opportunity amount displayed for some higher ranked opportunities.
iii. The net improvement opportunity is then calculated by subtracting the total opportunity costs from the gross improvement opportunity. The result could be positive or negative. If the gross improvement opportunity is negative (for example, a telemarketer makes more sales calls per lead than the best in their peer group to a specific customer segment to solicit for a specific product), the offsets, if any, would be positive (the time they would free up by not calling those specific leads as many times may be reallocated to other productive tasks). If, in absolute terms, the offsets are lower than the potential improvements, the net is still negative (in other words, in the example above, the telemarketer in focus does not need to make less calls to that specific customer segment to solicit for that particular product). However, it is also possible for the offsets to be greater in absolute terms. In that case, following the example above, the conclusion would be that the telemarketer in focus would be better off making fewer calls to the specific customer segment to solicit for the specific product and reallocating their time to the remaining productive tasks they perform.
iv. Scaling up and de-normalization—all opportunity sizing calculations in 7 c) use normalized performance data for a sub-period within a performance period. The only exception is opportunity costs that are direct monetary costs, which are not normalized (but are still scaled down to the measurement units for the opportunity being assessed). Therefore, similarly to the forecasting process described in 6, each net improvement opportunity is applied to the sub-periods for which the operational unit in focus is expected to be active (agent expected to work or store expected to be open), whether that is for the remaining sub-periods in the current performance period or for the entire following period for which the calculations are made. The gross improvement opportunities, opportunity costs assigned for taking productive time away from other tasks and those assigned for substitution are then de-normalized by applying the respective forecast factors. Direct monetary opportunity costs do not need to be de-normalized.
v. Improvements from zero base—A special case considered in the multifactorial analytical model is where the operational unit in focus is at zero in a given combination at a specific point in the operational value chain while the benchmark is above zero. For example, an insurance agent has not made an attempt to contact a specific customer segment although the agent has had leads to call on while the best in that agent's peer group have made attempts which have led to closed sales. In that case, the expected value from attempting to contact the assigned leads would be zero because there are no closed sales to base a different expected value on. That would result in a conclusion that attempting to contact those leads would be pointless from a sales perspective and when opportunity costs are taken into account it would actually be negative as it would take time away from productive tasks. In order to resolve this issue, the core analytical model refers to the average for the peer group expected value for the same combination. The average can be adjusted lower or higher by a factor (multiplier) depending on management judgment. Other solutions to this challenge are possible as well. One such solution is to look further back in time and see if the agent in focus has had time periods with successful attempts to contact the leads and has closed sales. But that would complicate the analytical process, especially if it is a high-volume, high-complexity, high frequency implementation. The core analytical model only performs the imputation and calculates a potential opportunity as described above only for the first point in the operational chain where the operational unit in focus has a zero. The potential improvement opportunities for that combination at the subsequent points in the operational chain are left at zero. The rationale is that from a management perspective it may be best to focus attention on the first point where there is failure (assuming zero indicates failure). In addition, attempting to make assumptions higher than zero for the prior points in the operational chain in order to generate values greater than zero at subsequent points would lead to assuming improvements at multiple points which would make management communications impractical and confusing (see FIG. 14).
d) Improvement opportunity prioritization—another key component to the present invention is the method for prioritizing improvement opportunities. It is an elimination (survival) algorithm which prioritizes values at more granular (lower) levels over values at more aggregate (higher) levels in a hierarchical structure defined by discrete positions along a single dimension or along multiple dimensions. The method can be applied in broad contexts, beyond this system, for prioritizing values in a hierarchical structure. The method overcomes a critical challenge present in drill-down analyses and system functionalities today—the ability to identify and prioritize values (or improvement opportunities, or net incremental benefits as is the case with the system presented in this invention) at lower levels in a hierarchical structure over higher levels in the same structure following an adaptable algorithm in an automated way, which makes it significantly faster, more accurate and more consistent than manual endeavors. For illustration, let us take the case where there are two products sold to two customer segments and the target performance metric is “sales”. Let us suppose the net incremental benefits from identified performance improvement opportunities for a particular salesperson are as shown in the table below.

| | Product A | Product B | Both Products |
|---|---|---|---|
| Customer Segment 1 | $965 | $10 | $975 |
| Customer Segment 2 | $10 | $15 | $25 |
| Both Segments | $975 | $25 | $1,000 |

There are three levels in the example above:
At the top is the total net incremental benefit across both products and customer segments ($1,000)
Then at the lower level are the following four cases
   Both products for customer segment 1 ($975)
   Both products for customer segment 2 ($25)
   Product A for both customer segments ($975)
   Product B for both customer segments ($25)
Finally, there is the lowest or most granular level:
   Product A for customer segment 1 ($965)
   Product B for customer segment 1 ($10)
   Product A for customer segment 2 ($10)
   Product B for customer segment 2 ($15)

A look at just the very top shows the total net incremental benefit is worth $1,000 in sales. The general and therefore not very actionable message from this message is “You have an extra $1,000 in sales you can achieve”. If the person performing the analysis is curious enough and has the time and skills to drill down, they would discover that the opportunity comes mostly from product A ($975). The message may change to “You have an extra $975 in sales if you focus more on product A”. That message is more specific and therefore more actionable as the attention is directed to one product in particular. If the person performing the analysis is even more curious and still has the time for extra analysis, they may drill down further and see that $965 comes from the combination “product A, customer segment 1”. The message may now change to “You have an extra $965 in sales if you focus more on selling product A to customer segment 1”. Although there will be some opportunity left out ($35), focus on a very specific and large enough opportunity could yield better results as the salesperson may be able to develop and execute a more effective improvement plan, faster. How deep in the analysis to go and where to put the threshold is subjective and left to individuals' discretion today. This invention incorporates an algorithm that automates the “drill-down” process. A percentage threshold is set at the beginning and that threshold can be reset at any time after that upon management's discretion. There is also a logic that establishes dependency lines. It then effectively eliminates from further consideration opportunities at the higher level that do not survive the comparison, with the threshold applied, to the opportunities coming from the lower levels upon which they depend. If the threshold is set at 90% or even 95% results will be as shown in the table below.

The way to interpret the table is that only the cells still showing numbers will be considered as improvement opportunities. Again, a more specific message to human beings who will be responsible execution or to machines that interact with humans with humans as the last actors in the chain (such as buyers) is expected to lead to better results, faster. The most conservative alternative is to set the threshold at 100%. In that case, opportunities from the lower levels need to be at least equal to the opportunities at the higher levels they define in order to eliminate them from further consideration. That will at least show if in extreme cases the entire opportunity comes from one specific combination at a lower level in the hierarchical structure. It should be noted it is possible for an opportunity at a lower level to be higher than an opportunity at a higher level if there are other combinations contributing to the same higher level opportunity that carry negative opportunities. It is unreasonable to expect for such analysis to be performed efficiently, accurately and consistently by hand as the possibilities in hierarchical structures are often in the hundreds or thousands. Therefore, this algorithm is best suited for a custom software application or, in the simplest use cases, it may be built on commonly used analytical platforms such as spreadsheet applications.

| | Product A | Product B | Both Products |
|---|---|---|---|
| Customer Segment 1 | $965 | $10 | |
| Customer Segment 2 | $10 | $15 | $25 |
| Both Segments | | $25 | |

e) Tie breakers—the following tie breakers can be set in the event two net improvement opportunities happen to be exactly the same in value:
   i. The first tie breaker is set at the combination level. Lower level combinations have higher priority as they are more specific.
   ii. Segmentation dimensions and the operational dimension are prioritized against each other. The priorities are up to the management team for each implementation.
   iii. There is also prioritization within each segmentation dimension and within the operational dimension.

Assigning combination identifiers reflecting the priority order is employed by one embodiment for this invention. If two or more combinations have equal improvement opportunity values after the prioritization logic described in 7 d) above has already been applied the combination identifier determines which combination is ranked higher. Below is an illustration how combination identifiers are assigned (a higher number means higher priority):
Cell Levels:
   1—Highest Level (all products and all customer segments)
   2—Middle Level (all products, specific customer segment or all customer segments, specific product)
   3—Lowest Level (specific product, specific customer segment—for example, product A, segment 1; product B, segment 1 and so on)
Segmentation dimensions: Product before Customer Segment (executed by placing the product priority before the customer segment priority in the combination identifier)
Within segmentation dimension:
   Product dimension
      3—Product A
      2—Product B
      1—Both Products
   Customer Segment
      3—Customer Segment 1
      2—Customer Segment 2
      1—Both Customer Segments

| Combination Identifiers | Product A | Product B | Both Products |
|---|---|---|---|
| Customer Segment 1 | 333 | 323 | 213 |
| Customer Segment 2 | 332 | 322 | 212 |
| Both Segments | 231 | 221 | 111 |

In the example showing the net improvement opportunities after prioritization in 7 d) we have a tie that needs to be broken. The improvement opportunities for the combination where Product is B and Customer Segment is 1 and the one where Product is A and Customer Segment is 2 are each $10. Given the assigned combination identifiers, since 332>323, the combination where Product is A and Customer Segment is 2 will be ranked higher (see below). In other embodiments, the same results can be achieved through ustom programming code.
f) Ranking: this is the final step in the analytical process for identifying, sizing, prioritization and ranking performance improvement opportunities. Higher values are ranked higher and with tie breakers described in 7 e) in place, there should not be any two improvement opportunities with the same ranking. The ranking includes all improvement opportunities—those requiring extra effort (such as working longer hours), better efficiency (for example, shorter but just as effective calls or less down time), extra skill (for example, higher closing rates or higher average sale) and just a higher starting opportunity (more leads assigned or a larger trade area, for example).
g) Detailed descriptions in plain English may be mapped to each combination in addition to the value for the net improvement opportunity for the current period (just for the remainder as described above) and possibly for the following period. The objective is to provide clear, accurate guidance to the users in order to make the insights immediately actionable, without further interpretation.

### 8. Full Potential

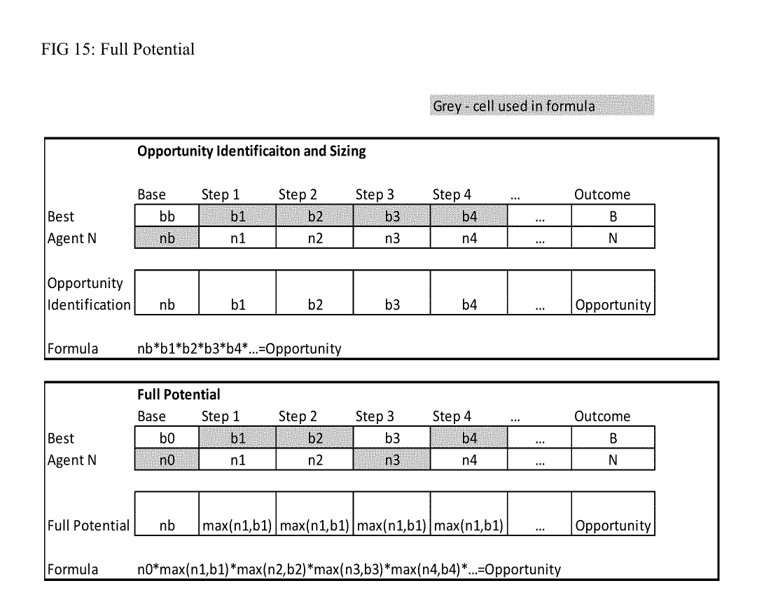

This is a component that estimates the full potential across all opportunities (see FIG. 15). The result can be different from the sum across all individual opportunities identified by component 5. The underlying assumption in the individual opportunity identification component described in item 7 above is that the operational unit in focus will only improve one thing and performance on other things may deteriorate (opportunity costs). In estimating the full potential, we assume effectiveness is not constrained. In other words, if the operational unit in focus is performing certain tasks worse than the best in the peer group, that unit can start performing them just as well and at the same time, if the operational unit in focus is already performing certain other tasks as or better than the best in the peer group performance on those tasks will not deteriorate. This component serves a different purpose from the one described in paragraph 7 above. It is about “How high can you reach from where you stand right now?”

### 9. Presentation

In a less complete implementation, a data presentation layer enables this system to be connected to other computerized systems, enabling results to be communicated through media and in formats chosen for the specific implementation.

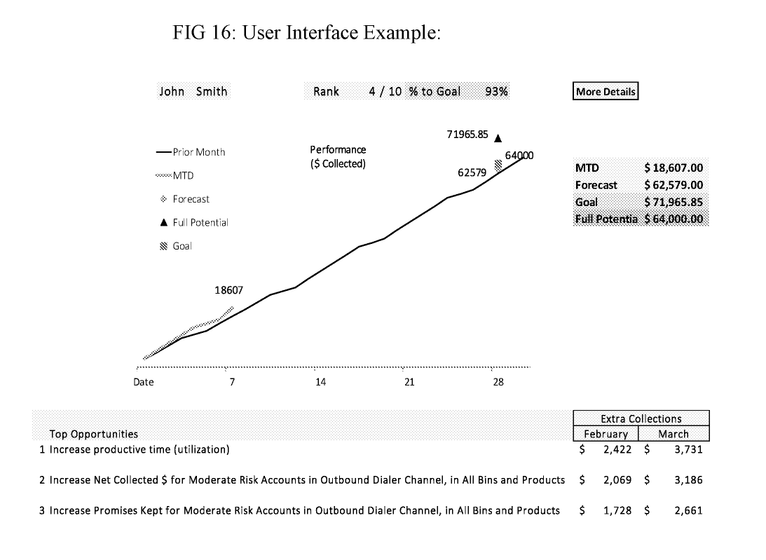

In its most complete form, this presentation component displays the results from analysis described above directly to end users. In addition to the data presentation layer, a user interface has been developed to go along with software applications (see FIG. 16 for an example). However, in simpler, implementations that do not involve sophisticated custom software applications, the insights may still be communicated to end users through simpler reporting means, even in tabular form. The key items shown below are reported for the various levels starting from the basic operational units and rolling all the way up to the organizational level. Additional data from the analyses may be added with each implementation at user discretion. Selected metrics commonly used in competitive, “pay for performance” environments may be added in order to make it the single performance management destination for end users. Here are the main items presented to the end users for the current and following periods:
a) “Business as usual” forecast
b) Full potential
c) Top improvement opportunities (values and plain language descriptions)—to draw attention to specific items and call for action

What is claimed is:

1. A computer-implemented method for forecasting performance and identifying, sizing and ranking performance improvement opportunities, the method comprising: a preparative analytics component wherein a basic operational unit is identified, a target performance metric is defined, an operational value chain is mapped (a process decomposition is performed), a segmentation is performed, comparison peer groups are established for each basic operational unit, dimensions in addition to operational unit and operational process value chain are identified, segments and hierarchies (roll-ups) within the dimensions are established, and forecasting factors are identified; a benchmark setting component including performance target setting and peer group performance averaging; a performance forecast for a single or multiple periods, from a basic operational unit to a highest organizational level; an analytical component for improvement opportunity identification, sizing and ranking, wherein performance improvement opportunities are identified based on comparisons to benchmarks, wherein potential benefits from identified performance improvement opportunities are calculated, wherein potential benefits from identified performance improvement opportunities are aggregated (rolled up) and wherein identified performance improvement opportunities are ranked by potential benefit.

2. The computer-implemented method according to claim 1 wherein said benchmark setting is executed through a quantitative, automated, adaptive method for performance target setting and peer group performance averaging.

3. The computer-implemented method according to claim 1 wherein said performance forecast is performed through a method employing normalized historical performance data and quantitatively established performance forecasting factors.

4. The computer-implemented method according to claim 1 wherein said analytical component for performance improvement opportunity identification, sizing and ranking is based on a multifactorial analytical method.

5. The computer-implemented method according to claim 4 wherein said multifactorial analytical method executes performance improvement opportunity identification through comparisons to performance targets that may start from a most granular level, which most granular level starts from a basic operational unit, and may include multiple dimensions, which multiple dimensions may comprise time, initial potential, operational value chain and multiple other segmentation dimensions specific to an operational environment or use case.

6. The computer-implemented method according to claim 4 wherein said multifactorial analytical method includes calculating potential benefits from identified performance improvement opportunities relative to performance targets and comparing potential benefits to corresponding potential opportunity costs to arrive at net incremental benefits for each possible multifactorial combination, at all levels in a hierarchical structure.

7. The computer-implemented method according to claim 1 further comprises an elimination (survival) algorithm which is applied in said analytical component for improvement opportunity identification, sizing and ranking, and which is designed to prioritize benefits from identified performance improvement opportunities in combinations at more granular (lower) levels over benefits at more aggregate (higher) levels in a hierarchical structure.

8. The computer-implemented method according to claim 1 wherein said analytical component for improvement opportunity identification, sizing, prioritization and ranking employs a tie breaker or, as applicable, tie breakers, in order to assign unique ranking to each potential benefit from performance improvement.

9. The computer-implemented method according to claim 1 further comprises a plain language mapping which is applied in said analytical component for improvement opportunity identification, sizing and ranking, the mapping assigning a plain language description to each possible multifactorial combination where a performance improvement opportunity may be identified.

10. The computer-implemented method according to claim 1 further comprises a calculation for full potential which is applied to each operational unit, starting from a basic operational unit and up to a highest organizational level, and which is applied to a single or multiple periods.

11. The computer-implemented method according to claim 1 further comprises a data presentation layer.

12. The computer-implemented method according to claim 12 further comprises a user interface.

13. A computer-implemented method for forecasting performance and identifying, sizing, prioritizing, ranking and presenting for execution performance improvement opportunities, the method comprising: a preparative analytics component wherein a basic operational unit is identified, a target performance metric is defined, an operational value chain is mapped (a process decomposition is performed), a segmentation is performed, comparison peer groups are established for each basic operational unit, dimensions in addition to operational unit and operational process value chain are identified, segments and hierarchies (roll-ups) within the dimensions are established, and forecasting factors are identified; a quantitative, automated, adaptive benchmarking setting component for performance target setting and peer group performance averaging; a performance forecast for a single or multiple time periods, from a basic operational unit to a highest organizational level, based on normalized historical performance data and quantitatively established performance forecasting factors; an analytical component based on a multifactorial analytical method for improvement opportunity identification, sizing, prioritization and ranking, wherein improvement opportunities are identified based on comparisons to adaptive benchmarks potentially at all levels in a hierarchical structure, potentially including multiple dimensions, which dimensions may comprise time, initial potential, operational value chain and multiple use-case specific segmentation factors, wherein potential benefits are calculated from identified performance improvement opportunities and compared to corresponding potential opportunity costs to arrive at net incremental benefits for each possible multifactorial combination at all levels in a hierarchical structure, wherein net incremental benefits are aggregated (rolled up) at all possible levels across all possible dimensions in a hierarchical structure, wherein an elimination (survival) algorithm is applied in order to prioritize net incremental benefits for combinations at more granular (lower) levels over net incremental benefits at more aggregate (higher) levels, wherein not eliminated (surviving) net incremental benefits for various multifactorial combinations are uniquely ranked, for each basic operational unit (most granular or lowest level in a hierarchy) and up to the highest level in an organization (highest level in a hierarchy), wherein a plain language description is assigned to each multifactorial combination in which a performance improvement opportunity may be identified; a calculation for full potential for each operational unit, starting from a most basic operational unit and up to a highest organizational level, for a single or multiple time periods; a presentation layer that may include a user interface and that is used to indirectly or directly present analysis data and information.

14. A computer-implemented method comprising an elimination (survival) algorithm which prioritizes values at more granular (lower) levels over values at more aggregate (higher) levels in a hierarchical structure defined by discrete positions along a single dimension or along multiple dimensions.
